(19) United States
(12) Patent Application Publication
(10) Pub. No.: US 2014/0351876 A1
(43) Pub. Date: Nov. 27, 2014

(54) BROADCAST RECEIVER AND COMPUTER PROGRAM PRODUCT

(71) Applicant: KABUSHIKI KAISHA TOSHIBA, Tokyo (JP)

(72) Inventor: Jun Kano, Ome-shi (JP)

(73) Assignee: KABUSHIKI KAISHA TOSHIBA, Tokyo (JP)

(21) Appl. No.: 14/147,422

(22) Filed: Jan. 3, 2014

(30) Foreign Application Priority Data
May 24, 2013 (JP) 2013-110041

(51) Int. Cl. H04N 21/41

(52) U.S. Cl. CPC H04N 21/4122; H04N 21/4126
USPC 725/133

(57) ABSTRACT

According to one embodiment, a broadcast receiver has a receiving module, a display controller and an output module. The output module is configured to output, when a first display module changes from a first state where a first video image is displayed to a second state where a second video image is displayed, first instruction to at least a first information processor configured to switch a second display module of the first information processor from a third state where first content is displayed to a fourth state where second content is displayed and configured to maintain a third display module of a second information processor in the third state. The first and second content are based upon the first and second video images, respectively.

### CROSS-REFERENCE TO RELATED APPLICATIONS

This application is based upon and claims the benefit of priority from Japanese Patent Application No. 2013-110041, filed May 24, 2013, the entire contents of which are incorporated herein by reference.

### FIELD

Embodiments described herein relate generally to a broadcast receiver and a computer program product.

### BACKGROUND

Conventionally, there have been known techniques to display, on information processors such as mobile terminals, content corresponding to video images displayed on broadcast receivers such as television devices. In such conventional techniques, the content displayed on the information processors is automatically changed (switched) in response to changes in video images of the broadcast receivers when the video images displayed on the broadcast receivers change.

In the techniques, it is preferable that the content displayed on the information processors can be maintained without any change in addition to being switched when the video images displayed on the broadcast receivers change, for example.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram illustrating an overall structure of a video image display system comprising a television device according to a first embodiment;

FIG. 2 is an exemplary block diagram illustrating an internal structure of the television device, a smartphone, a tablet and a remote controller in the first embodiment;

FIG. 3 is an exemplary schematic diagram illustrating an operation screen for operating the television device displayed on a display module of the smartphone in the first embodiment;

FIG. 4 is an exemplary schematic diagram illustrating the operation screen for operating the television device displayed on a display module of the tablet in the first embodiment;

FIG. 5 is an exemplary schematic diagram illustrating a first table stored in the television device in the first embodiment;

FIG. 6 is an exemplary schematic diagram illustrating a second table stored in the television device in the first embodiment;

FIG. 7 is an exemplary schematic diagram illustrating a third table stored in the television device in the first embodiment;

FIG. 8 is an exemplary schematic diagram roughly explaining transitions of display screens displayed on the respective display modules of the television device, the smartphone, and the tablet before and after the occurrence of an event that changes a video image displayed on a display module of the television device in the first embodiment;

FIG. 9 is an exemplary schematic diagram explaining the transition of the display screen displayed on the display module of the smartphone when the video image displayed on the display module of the television device changes, in the first embodiment;

FIG. 10 is an exemplary schematic diagram explaining the transition of the display screen displayed on the display module of the tablet when the video image displayed on the display module of the television device changes, in the first embodiment;

FIG. 11 is an exemplary schematic diagram explaining the transition of the display screen displayed on the display module of the smartphone when the video image displayed on the display module of the television device changes, in the first embodiment;

FIG. 12 is an exemplary schematic diagram explaining the transition of the display screen displayed on the display module of the tablet when the video image displayed on the display module of the television device changes, in the first embodiment;

FIG. 13 is an exemplary schematic diagram explaining the transition of the display screen displayed on the display module of the tablet when the video image displayed on the display module of the television device changes, in the first embodiment;

FIG. 14 is an exemplary flowchart of processing performed by a controller of the television device in the first embodiment; and

FIG. 15 is an exemplary flowchart of processing performed by a controller of a television device according to a second embodiment.

### DETAILED DESCRIPTION

In general, according to one embodiment, a broadcast receiver comprises a receiving module, a display controller and an output module. The receiving module is configured to receive broadcast waves. The display controller is configured to output display data causing a first display module to display a video image based upon the broadcast waves. The output module is configured to output, when the first display module changes from a first state where a first video image is displayed to a second state where a second video image is displayed, first instruction to at least a first information processor configured to switch a second display module of the first information processor from a third state where first content is displayed to a fourth state where second content is displayed and configured to maintain a third display module of a second information processor in the third state. The first and the second information processing devices are coupled to the broadcast receiver. The first and second content are based upon the first and second video images, respectively.

The following embodiments include the same components. The same components are labeled with the same reference numerals and duplicated descriptions thereof are omitted. The embodiments including the same components can obtain the same results (advantageous effects) based on the same components. Ordinal numbers such as a first and a second are labeled in the present specification to differentiate the components for the sake of convenience and do not mean an order, a priority, or a level of importance of processing, for example.

### First Embodiment

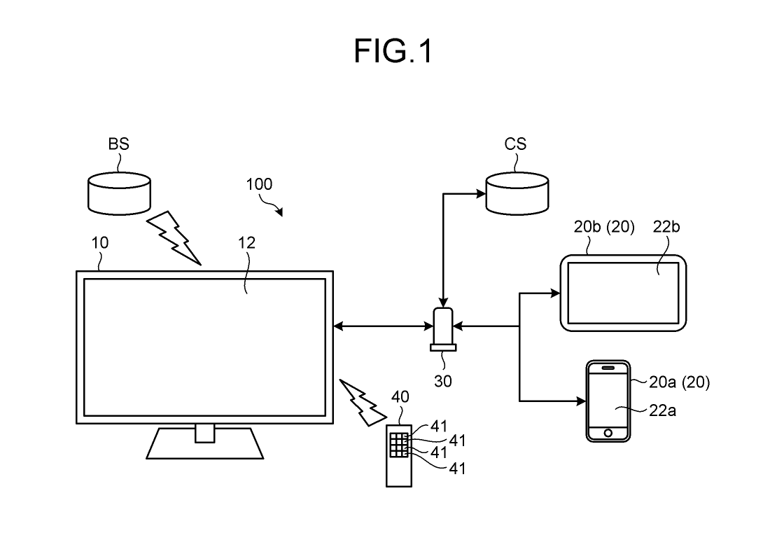

The following describes an example of a structure of a video image display system 100 comprising a television device 10 according to a first embodiment with reference to FIGS. 1 to 13. The television device 10 is an example of a “broadcast receiver”.

As illustrated in FIG. 1, the video image display system 100 comprises the television device 10 and a plurality of (two pieces in FIG. 1) mobile terminals 20 (a smartphone 20a and a tablet 20b). The television device 10 and the mobile terminals 20 are coupled through a network (such as a home network or the Internet) so as to enable communication therebetween. Specifically, the television device 10 and the mobile terminals 20 are coupled through a router 30, which is an appliance comprised in the network, so as to enable communication therebetween. The mobile terminals 20 (the smartphone 20a and the tablet 20b) are examples of an “information processor (electronic device)”. The smartphone 20a is an example of a “first information processor” and the tablet 20b is an example of a “second information processor”.

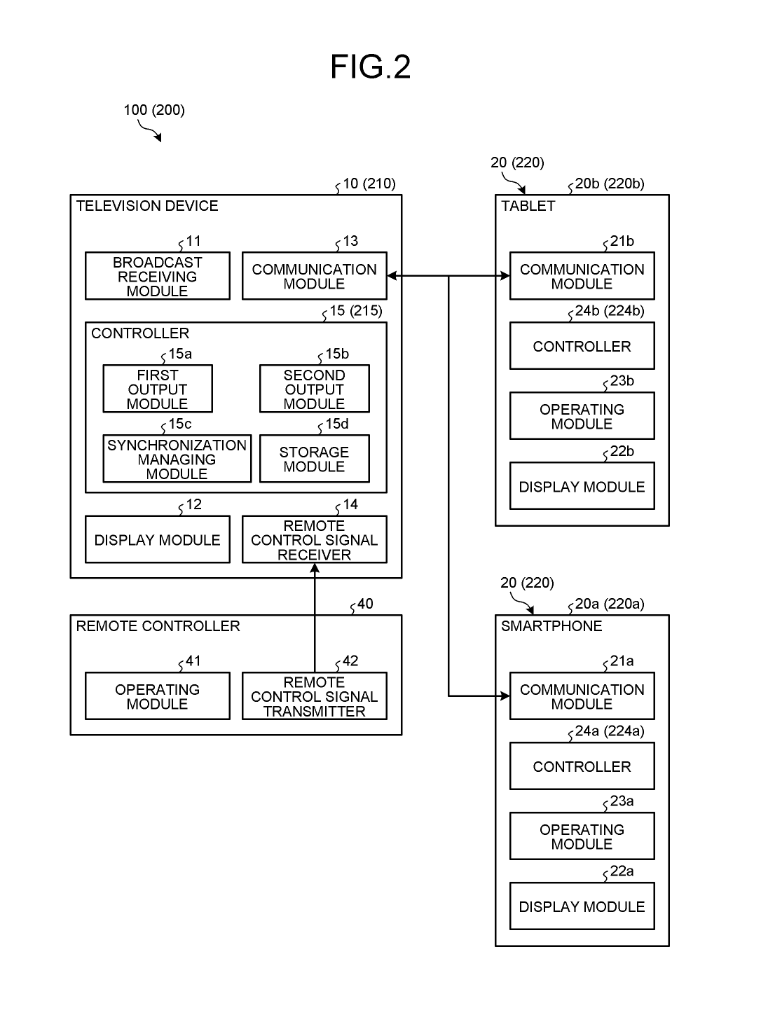

As illustrated in FIG. 2, the television device 10 comprises a broadcast receiving module 11, a display module 12, a communication module 13, a remote control signal receiver 14, and a controller 15. The broadcast receiving module 11 is an example of a “receiving module”, the display module 12 is an example of a “first display module”, and the communication module 13 is an example of an “acquisition module”. The controller 15 of the television device 10 comprises a first output module 15a, a second output module 15b, a synchronization managing module 15c, and a storage module 15d. The first output module 15a is an example of a “display controller” and the second output module 15b is an example of a “output module”.

The smartphone 20a, which is the mobile terminal 20, comprises a communication module 21a, a display module 22a, an operating module 23a, and a controller 24a. The tablet 20b, which is the mobile terminal 20, comprises a communication module 21b, a display module 22b, an operating module 23b, and a controller 24b in the same manner as the smartphone 20a. The display module 22a is an example of a “second display” and the display module 22b is an example of a “third display”.

The broadcast receiving module 11 of the television device 10 receives broadcast waves transmitted from a broadcast station BS (refer to FIG. 1). The display module 12 of the television device 10 can display video images corresponding to the broadcast waves received by the broadcast receiving module 11 (e.g., television programs corresponding to channels of broadcasting). The first output module 15a of the controller 15 of the television device 10 outputs display data that causes the display module 12 to display the video images corresponding to the broadcast waves.

The communication module 13 of the television device 10 is communicably connected to the communication module 21a of the smartphone 20a and the communication module 21b of the tablet 20b through the router 30. The communication module 13 makes it possible to exchange various types of data (e.g., first, second, third, and fourth instruction data, which are described later) between the television device 10 and the smartphone 20a (the tablet 20b).

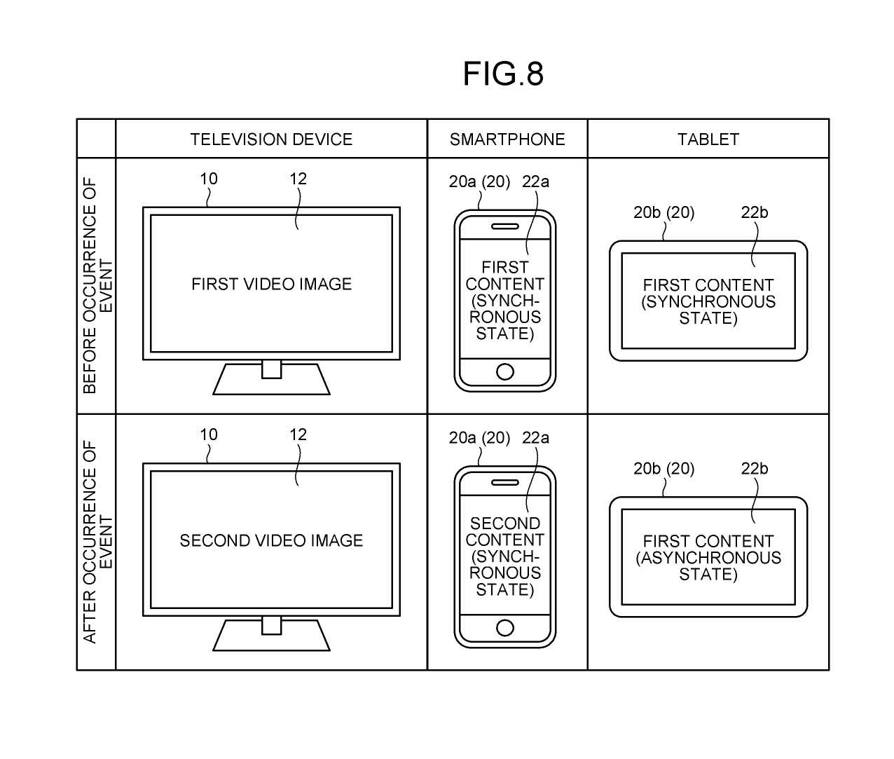

The remote control signal receiver 14 of the television device 10 receives a remote control signal transmitted from a remote controller 40. The remote control signal is transmitted from a remote control signal transmitter 42 on the basis of the operation of an operating module 41. A user can operate the television device 10 using the remote controller 40. For example, a video image displayed on the display module 12 is changed from a first video image to a second video image (refer to FIG. 8) by operation, performed by a user, of switching (changing) the channel of television broadcasting from the first channel to the second channel using the remote controller 40. The first video image corresponds to (content of) a first channel and the second video image corresponds to (content of) a second channel. The television device 10 is provided with an operating module (not illustrated in FIG. 2) used for operating the television device 10. A user can also operate the television device 10 by operation of the operating module of the television device 10.

A user can also operate the television device 10 using the smartphone 20a and the tablet 20b. That is, a user of the tablet 20b can perform operation of switching a video image displayed on the display module 12 of the television device 10 (switching a channel of television broadcasting) by operation of the operating module 23b of the tablet 20b, for example. Likewise, a user of the smartphone 20a can perform operation of switching a video image displayed on the display module 12 of the television device 10 (switching a channel of television broadcasting) by operation of the operating module 23a of the smartphone 20a, for example. When the operation of the television device 10 (switching operation of a video image on the display module 12) using the tablet 20b (the smartphone 20a) is performed in this way, data (the third instruction data) instructing the television device 10 to switch the video image displayed on the display module 12 is transmitted from the tablet 20b (the smartphone 20a) to the television device 10.

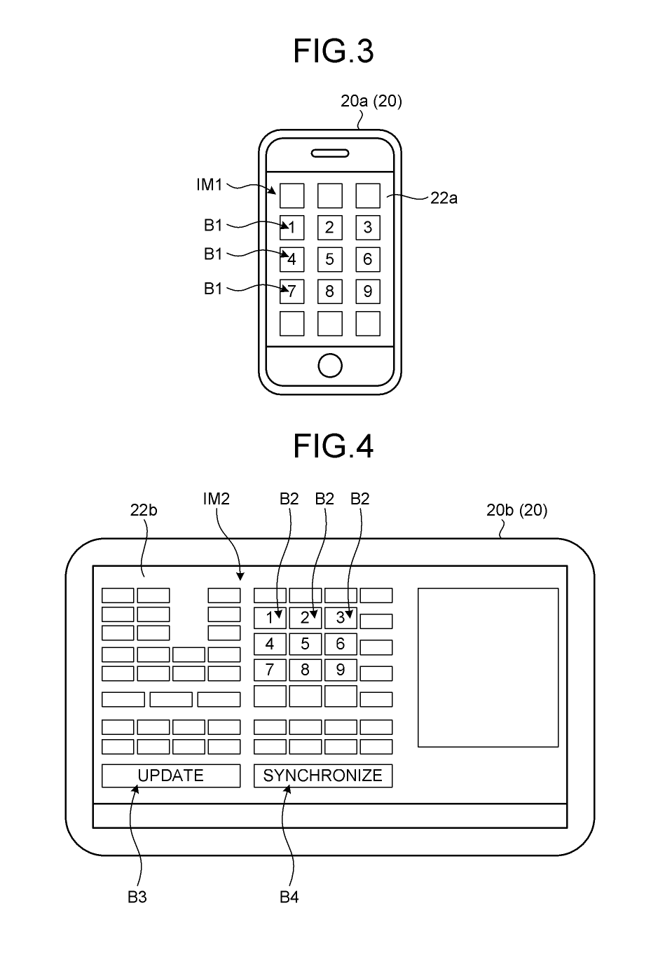

In the first embodiment, the operating module 23a of the smartphone 20a is structured with a touch panel using the display module 22a, for example. Likewise, the operating module 23b of the tablet 20b is also structured with a touch panel using the display module 22b, for example. The display module 22a of the smartphone 20a is structured so as to enable it to display an operation screen IM1 (refer to FIG. 3) used for operating the television device 10 (e.g., channel changing operation). Likewise, the display module 22b of the tablet 20b is also structured so as to enable it to display an operation screen IM2 (refer to FIG. 4) used for operating the television device 10. On the operation screen IM1 of FIG. 3, a plurality of channel selection buttons B1 (numbers of “1”, “2”, . . . , “9” are displayed thereon) used for the channel changing (selecting, switching) operation are displayed, for example. On the operation screen IM2 of FIG. 4, an update button B3 and a synchronization button B4 are displayed, which are described later, in addition to a plurality of channel selection buttons B2, for example.

In the first embodiment, the display module 22a (22b) of the smartphone 20a (the tablet 20b) can display content (e.g., an image, a character, and the video image) corresponding to the video image displayed on the display module 12 of the television device 10. This state is called a synchronous state. On the other hand, a state is called an asynchronous state in which the content corresponding to the video image displayed on the display module 12 of the television device 10 is not displayed by the smartphone 20a (the tablet 20b).

The switching or maintaining of the display screen on the display module 22a (22b) of the smartphone 20a (the tablet 20b) is performed on the basis of the instruction data (the first and the second instruction data) output from the second output module 15b of the controller 15 of the television device 10. The first and the second instruction data are transmitted from the television device 10 to the smartphone 20a (the tablet 20b) through the network. The controller 24a (24b) of the smartphone 20a (the tablet 20b) controls the display module 22a (22b) on the basis of the first and the second instruction data acquired through the communication module 21a (21b).

The synchronous state is achieved by the following procedure, for example. A video image corresponding to (content of) a channel of broadcast waves is displayed on the display module 12 of the television device 10. The television device 10 transmits, to the smartphone 20a (the tablet 20b), the instruction data (e.g., data, address data, and identification data such as a uniform resource locator (URL)), which is included in the broadcast waves, corresponding to (the content of) the channel of the video image displayed on the display module 12. The smartphone 20a (the tablet 20b) acquires the content corresponding to the instruction data from a content server CS (refer to FIG. 1) on the network in the form of a hyper text markup language (HTML) document including images and moving images, for example. As a result, the content corresponding to the video image displayed on the display module 12 of the television device 10 is displayed on the display module 22a (22b) of the smartphone 20a (the tablet 20b).

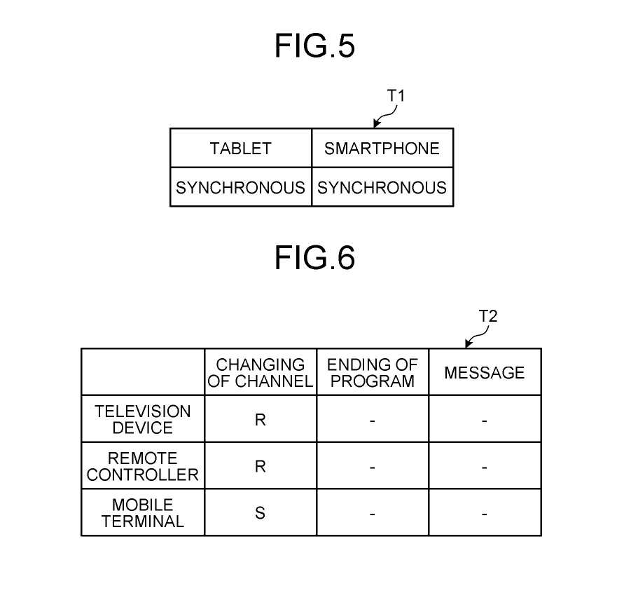

In the first embodiment, the controller 15 of the television device 10 manages whether the television device 10 and the smartphone 20a (the tablet 20b) are in the synchronous state or the asynchronous state. Specifically, the storage module 15d of the controller 15 stores therein a first table T1 (information, setting information, or settings, refer to FIG. 5) indicating whether the television device 10 and the smartphone 20a (the tablet 20b) are in the synchronous state or in the asynchronous state. The synchronization managing module 15c of the controller 15 performs management to maintain or update (rewrite) the first table T1 stored in the storage module 15d, for example. FIG. 5 illustrates that the television device 10 and the smartphone 20a are in the synchronous state and the television device 10 and the tablet 20b are also in the synchronous state, as an example. In the first embodiment, a user can variously set and change the contents of the first table T1. In the first embodiment, information of any format is usable besides the information of a table format such as the first table T1 if the information can identify the relation (the synchronous state or the asynchronous state) between the television device 10 and the smartphone 20a (the tablet 20b).

In the first embodiment, when an event that changes the video image displayed on the display module 12 of the television device 10 occurs, the synchronization managing module 15c of the controller 15 maintains or updates the first table Ti in accordance with the event, for example. Examples of events that change the video image displayed on the display module 12 of the television device 10 include channel changing operation of a television program, starting of a new television program upon ending of a certain television program, and a forced changing of content of broadcast waves due to an appealing message for users that the broadcast station BS (refer to FIG. 1) puts on the broadcast waves.

The synchronization managing module 15c of the controller 15 maintains or updates the first table T1 on the basis of a second table T2 (information, setting information, or settings, refer to FIG. 6) stored in the storage module 15d. The second table T2 of FIG. 6 specifies that the first table T1 is updated (“R”: all synchronizations are cancelled and “S”: other synchronizations excluding itself are cancelled) when the channel changing operation is a factor of the occurrence of the event that changes the video image displayed on the display module 12 of the television device 10, as an example. The second table T2 also specifies that the first table T1 is not updated (“-”: no change) when the ending of a television program and the message that the broadcast station BS (refer to FIG. 1) puts on broadcast waves are the factors of the occurrence of the event that changes the video image displayed on the display module 12 of the television device 10.

More specifically, the second table T2 of FIG. 6 specifies, as an example, that all of the synchronous states of the mobile terminals 20 in the synchronous state with the television device 10 are cancelled (the relation between the television device 10 and the mobile terminals 20 is changed from the synchronous state to the asynchronous state) (“R”: all synchronizations are cancelled) in the following cases: a case where the channel changing operation is performed using the operating module (not illustrated in FIG. 2) of the television device 10, and a case where the channel changing operation is performed using the operating module 41 of the remote control signal receiver 14. The second table T2 also specifies that, when the channel changing operation is performed using the operating module (the operating module 23b or 23a) of the mobile terminal 20 (the tablet 20b or the smartphone 20a) , the synchronous states of other mobile terminals 20 excluding the mobile terminal 20 performing the channel changing operation are cancelled (“S”: other synchronizations excluding itself are cancelled). In the first embodiment, a user can variously set and change the contents of the second table T2. In the first embodiment, information of any format is usable besides the information of a table format such as the second table T2 if the information can associate the event that changes the video image displayed on the display module 12 of the television device 10 and an updating rule of the relation (the synchronous state or the asynchronous state) between the television device 10 and the mobile terminal 20 with each other.

As illustrated in FIG. 8, in the first embodiment, the relation between the television device 10 and the smartphone 20a is maintained in the synchronous state whereas the relation between the television device 10 and the tablet 20b is changed from the synchronous state to the asynchronous state on the basis of the settings in the first table T1 and the second table T2, when the event changing the video image displayed on the display module 12 of the television device 10 from the first video image to the second video image occurs due to the channel changing operation by a user of the smartphone 20a in the case that the relation between the television device 10 and the smartphone 20a is in the synchronous state and the relation between the television device 10 and the tablet 20b is in the synchronous state, for example. Specifically, the display module 22a of the smartphone 20a changes from a state where first content corresponding to the first video image is displayed to a state where second content corresponding to the second video image is displayed whereas the display module 22b of the tablet 20b maintains the state where the first content is displayed.

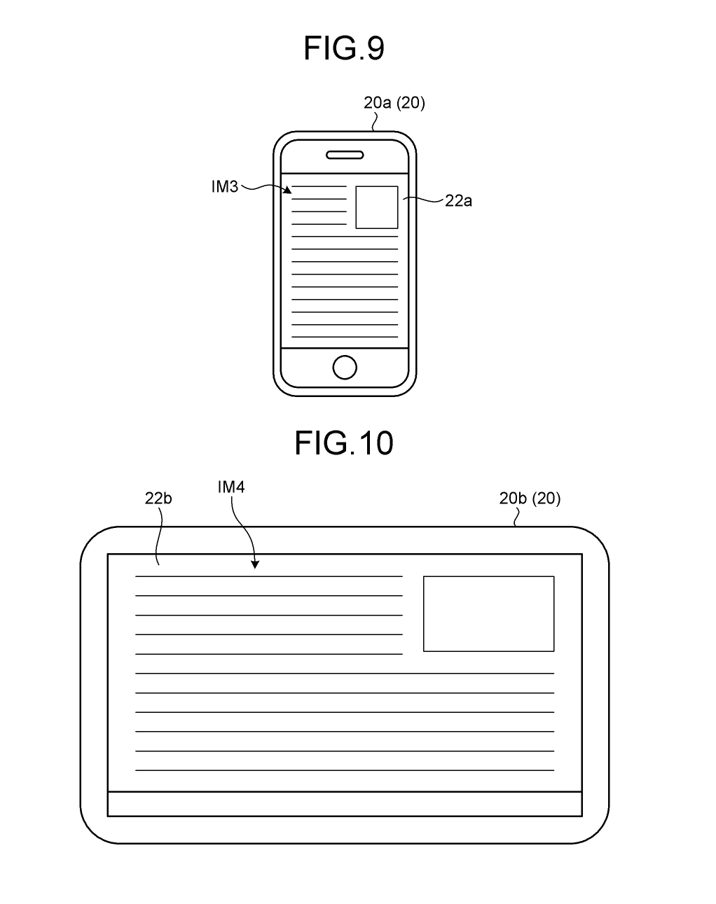

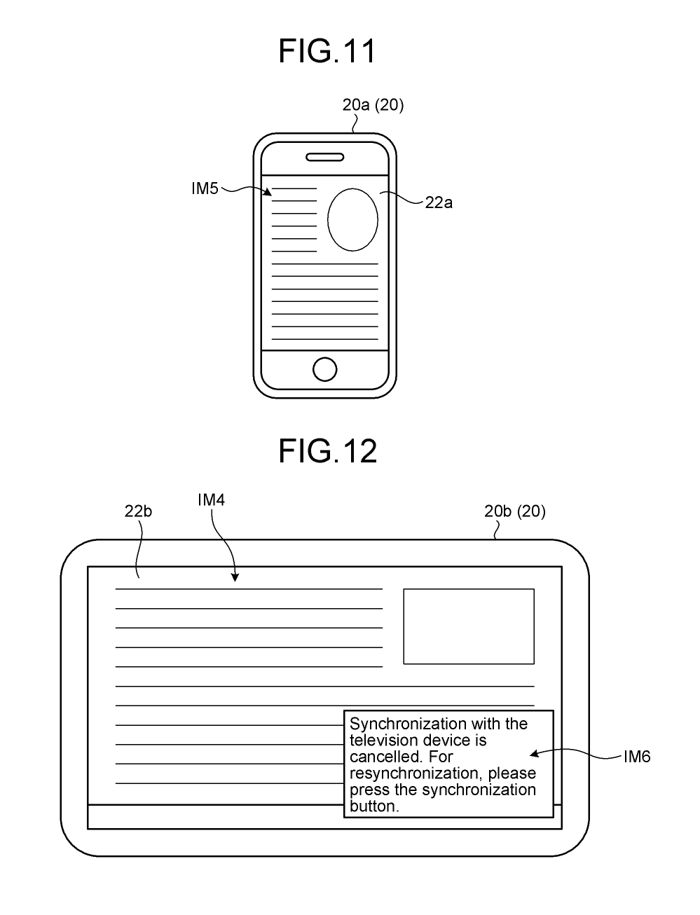

That is, in the first embodiment, an image IM3 (refer to FIG. 9) corresponding to the first content (refer to FIG. 8) is displayed on the display module 22a of the smartphone 20a while an image IM4 (refer to FIG. 10) corresponding to the first content is displayed on the display module 22b of the tablet 20b when the relation between the television device 10 and the smartphone 20a, and the relation between the television device 10 and the tablet 20b are both in the synchronous state, for example. When the channel changing operation is performed using the smartphone 20a (when a user performs operation of touching the channel selection button B1 on the operation screen IM1 of FIG. 2), the display module 22a of the smartphone 20a changes from the state where the image IM3 corresponding to the first content is displayed to a state where an image IM5 (refer to FIG. 11) corresponding to the second content (refer to FIG. 8) is displayed, while the display module 22b of the tablet 20b maintains the state where the image IM4 corresponding to the first content is displayed.

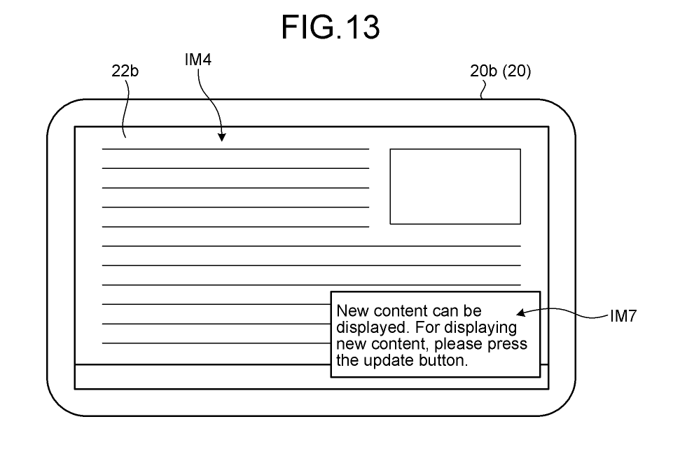

At the time, as illustrated in FIG. 12, an image IM6 is displayed on the display module 22b of the tablet 20b such that the image IM6 overlaps with part of the image IM4 corresponding to the first content (refer to FIG. 8). The image IM6 notifies a user that the synchronization with the television device 10 is cancelled. The image IM6 displays the following message: “Synchronization with the television device is cancelled. For resynchronization, please press the synchronization button”. After the image IM6 has disappeared, as illustrated in FIG. 13, an image IM7 such that the image IM7 overlaps with part of the image IM4 corresponding to the first content. The image IM7 notifies a user that the display screen is switchable from the first content to the second content (refer to FIG. 8). The image IM7 displays the following message: “New content can be displayed. For displaying new content, please press the update button”.

The “synchronization button” described in the message of the image IM6 (refer to FIG. 12) and the “update button” described in the message of the image IM7 (refer to FIG. 13) are both displayed on the operation screen IM2 (refer to FIG. 4) used for operating the television device 10. A user of the tablet 20b can return the relation between the television device 10 and the tablet 20b from the asynchronous state to the synchronous state by performing operation of pressing down (touching) the synchronization button B4 on the operation screen IM2. A user of the tablet 20b can also switch the content displayed on the display module 22b of the tablet 20b from the first content to the second content by performing operation of touching the update button B3 on the operation screen IM2.

In the first embodiment, the second output module 15b of the controller 15 of the television device 10 outputs the first instruction data to the smartphone 20a or the tablet 20b, when the video image displayed on the display module 12 changes, so as to switch (or maintain) the content displayed on the display module 22a (22b) of the smartphone 20a (the tablet 20b). For example, in the examples illustrated in FIGS. 9 to 13, the second output module 15b outputs the first instruction data to at least the smartphone 20a that is set to change the content so as to switch the display module 22a of the smartphone 20a from the state where the image IM3 is displayed to the state where the image IM5 is displayed, and so as to maintain the display module 22b of the tablet 20b in the state where the image IM4 is displayed. The second output module 15b may output the first instruction data instructing the tablet 20b to maintain the content displayed to the tablet 20b that is set to maintain the content displayed.

In the first embodiment, the second output module 15b outputs the second instruction data to the smartphone 20a or the tablet 20b, when the video image displayed on the display module 12 of the television device 10 changes from the first video image to the second video image (refer to FIG. 8), so as to cause the display module 22a (22b) of the smartphone 20a (the tablet 20b) to display the image indicating that the display module 22a (22b) is switched or switchable from the state where the first content is displayed to the state where the second content is displayed. For example, in the examples illustrated in FIGS. 9 to 13, the second output module 15b outputs the second instruction data to the tablet 20b so as to display, on the image IM4 displayed on the display module 22b of the tablet 20b, the image IM7 (refer to FIG. 13) indicating that the content is switchable.

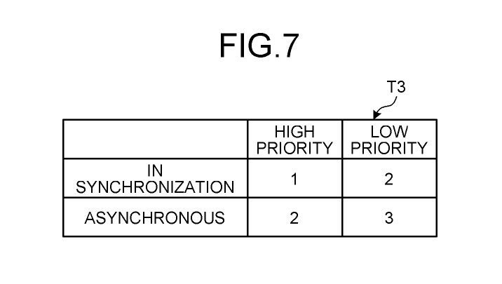

Information, which is included in the second instruction data output from the second output module 15b, can be determined on the basis of a third table T3 (information, setting information, or settings, refer to FIG. 7) stored in the storage module 15d. The information relates to display formats with which the display screens of the display modules (the display module 22a and the display module 22b) of the mobile terminals 20 (the smartphone 20a and the tablet 20b) are switched or maintained.

The third table T3 of FIG. 7 specifies, as an example, that an image corresponding to old content (e.g., the image IM3 of FIG. 9) is not displayed while an image corresponding to new content (e.g., the image IM5 of FIG. 11) is displayed (“1”: load content and display it on the foreground) when the relation between the television device 10 and the mobile terminal 20 as a transmission target of the second instruction data is in the synchronous state (“in synchronization”), and a predetermined flag included in broadcast waves is a “high priority”. The flag is information, which is designated by the broadcast station BS (refer to FIG. 1) , indicating a priority of processing to switch or to maintain the content displayed on the display module of the mobile terminal 20. The third table T3 specifies that an image (e.g., the image IM7 of FIG. 13) is displayed that indicates that an image corresponding to new content is switchable while the state where the display of an image corresponding to old content is maintained (“2” : load content and send notification but do not display it on the foreground) when the relation between the television device 10 and the mobile terminal 20 as a transmission target of the second instruction data is in the synchronous state (“in synchronization”), and the predetermined flag included in broadcast waves is a “low priority”.

The third table T3 of FIG. 7 specifies, as an example, that an image (e.g., the image IM7 of FIG. 13) indicating that an image corresponding to new content is switchable is displayed while the state where the display of an image corresponding to old content is maintained when the relation between the television device 10 and the mobile terminal 20 as a transmission target of the second instruction data is in the asynchronous state (“asynchronous”), and the predetermined flag included in broadcast waves is the “high priority”. The third table T3 of FIG. 7 specifies that no new image is displayed while the display of an image corresponding to old content is maintained without any change (“3”: no notification is sent) when the relation between the television device 10 and the mobile terminal 20 as a transmission target of the second instruction data is in the asynchronous state (“asynchronous”), and the predetermined flag included in broadcast waves is the “low priority”. In the first embodiment, a user can variously set and change the contents of the third table T3. In the first embodiment, information of any format is usable besides the information of a table format such as the third table T3 if the information can specify a display format (display style) with which the content displayed on the smartphone 20a (the tablet 20b) is switched or maintained.

In the first embodiment, when the synchronous state between the television device 10 and the smartphone 20a (the tablet 20b) is cancelled (when the synchronous state is changed to the asynchronous state), the second output module 15b can output the fourth instruction data to the smartphone 20a (the tablet 20b), the synchronous state of which is cancelled so as to cause the display module 22a (22b) to display an image notifying a user of the cancellation. For example, in the examples illustrated in FIGS. 9 to 13, the image IM6 (refer to FIG. 12) is displayed on the display module 22b of the tablet 20b such that the image IM6 overlaps with part of the image IM4 corresponding to the first content due to the fourth instruction data output at a stage when the synchronous state of the television device 10 and the tablet 20b is cancelled before the second instruction data is output. The image IM6 notifies a user that the synchronization with the television device 10 is cancelled. The second instruction data is the instruction data to cause the display module 22b of the tablet 20b display image IM7 (refer to FIG. 13) indicating that the content is switchable.

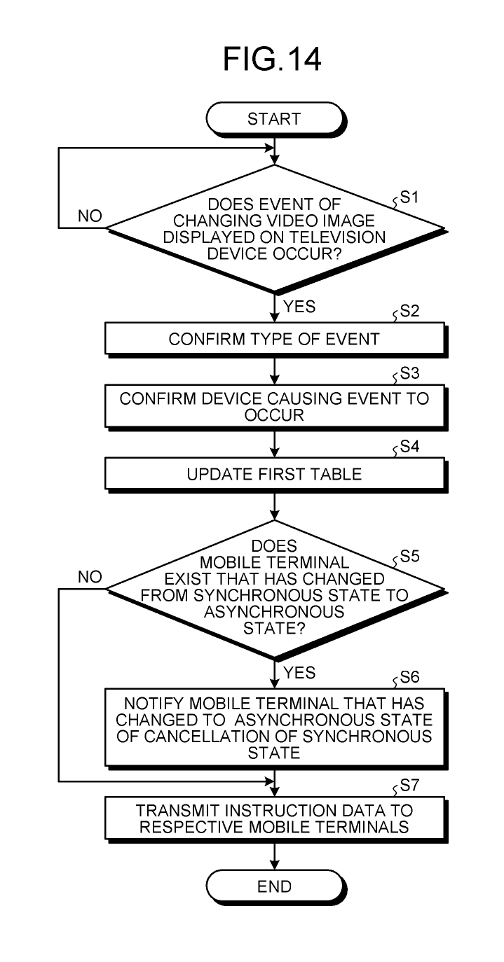

The following describes a flowchart of processing performed by the controller 15 of the television device 10 in the first embodiment with reference to FIG. 14.

In the processing flow illustrated in FIG. 14, at S1, processing is performed that determines whether the event of changing the video image displayed on the display module 12 of the television device 10 occurs. The processing at S1 is repeated until it is determined that the event of changing the video image displayed on the display module 12 of the television device 10 has occurred. If it is determined, at S1, that the event of changing the video image displayed on the display module 12 of the television device 10 has occurred, the processing proceeds to S2.

At S2, processing is performed that confirms the type of event whose occurrence is determined at S1. That is, the processing is performed that confirms that the event whose occurrence is determined at S1 corresponds to any of the various events such as: the channel changing operation of a television program by any of the television device 10, the remote control signal receiver 14, and the mobile terminal 20 (the smartphone 20a or the tablet 20b); the starting of a new television program upon ending of a certain television program; and a forced changing of the contents of broadcast waves due to an appealing message for users that the broadcast station BS (refer to FIG. 1) puts on the broadcast waves. Then, the processing proceeds to S3.

At S3, processing is performed that confirms the device causing the occurrence of the event confirmed at S2. For example, when it is confirmed at S2 that the event causing the video image displayed on the display module 12 of the television device 10 to change is the channel changing operation of a television program, the processing is performed that confirms whether the device that has performed the channel changing operation of the television program is any of the television device 10, the remote control signal receiver 14, and the mobile terminal 20 (the smartphone 20a or the tablet 20b). Then, the processing proceeds to S4.

At S4, processing is performed that updates the first table T1 (refer to FIG. 5) stored in the storage module 15d on the basis of the confirmation results at S2 and S3. At S4, it is determined how to update the first table T1 with reference to the second table T2 (refer to FIG. 6) stored in the storage module 15d on the basis of the confirmation results at S2 and S3. For example, when it is confirmed at S2 and S3 that the event changing the video image displayed on the display module 12 of the television device 10 occurs due to the channel changing operation by a user and the device performing the channel changing operation is the smartphone 20a, the column corresponding to the tablet 20b in the first table T1 is updated to “asynchronous” so as to cancel the synchronous state of the mobile terminal 20 (the tablet 20b) excluding the smartphone 20a on the basis of the second table T2. The updating processing is performed by the synchronization managing module 15c of the controller 15. Then, the processing proceeds to S5.

At S5, processing is performed that determines whether the mobile terminal 20 exists that has changed from the synchronous state to the asynchronous state as a result of the processing at S4. If it is determined, at S5, that no mobile terminal 20 exists that has changed from the synchronous state to the asynchronous state, the processing proceeds to S7, which is described later. If it is determined, at S5, that the mobile terminal 20 exists that has changed from the synchronous state to the asynchronous state, the processing proceeds to S6.

At S6, processing is performed that notifies the mobile terminal 20 that has changed to the asynchronous state as a result of the processing at S4 of the cancellation of the synchronous state. For example, in the examples illustrated in FIGS. 9 to 13, the image IM6 (refer to FIG. 12) is displayed on the display module 22b of the tablet 20b that notifies the cancellation of the synchronous state because the synchronous state of the tablet 20b is cancelled at S4. Then, the processing proceeds to S7.

At S7, processing is performed that transmits the instruction data (the first and the second instruction data) output by the second output module 15b on the basis of the third table T3 (refer to FIG. 7) to the respective mobile terminals 20 (the smartphone 20a and the tablet 20b) coupled to the television device 10 so as to enable communication therebetween. For example, in the examples illustrated in FIGS. 9 to 13, the first instruction data is transmitted to the smartphone 20a and the tablet 20b so as to switch the display module 22a of the smartphone 20a from the state where the image IM3 (refer to FIG. 9) is displayed to the state where the image IM5 (refer to FIG. 11) is displayed, and so as to maintain the display module 22b of the tablet 20b in the state where the image IM4 (refer to FIGS. 10, 12, and 13) is displayed. In the examples illustrated in FIGS. 9 to 13, the second instruction data is transmitted to the tablet 20b so as to display, on the image IM4 displayed on the display module 22b of the tablet 20b, the image IM7 (refer to FIG. 13) indicating that the content is switchable. Thereafter, the processing ends.

As describe above, in the first embodiment, when the display module 12 of the television device 10 changes from the state (first state) where the first video image is displayed to the state (second state) where the second video image is displayed (e.g., the channel changing operation is performed using the smartphone 20a), the second output module 15b of the controller 15 of the television device 10 outputs the first instruction data to the smartphone 20a and the tablet 20b so as to switch the display module 22a of the smartphone 20a from the state (third state) where the first content is displayed (refer to FIG. 9) to the state (fourth state) where the second content is displayed (refer to FIG. 11), and so as to maintain the display module 22b of the tablet 20b in the state where the first content is displayed (refer to FIGS. 10, 12, and 13). The first and second content correspond to the first and second video images, respectively. As a result, the content displayed on the smartphone 20a can be switched and the content displayed on the tablet 20b can be maintained without any change when the video image displayed on the television device 10 changes, for example.

In the structure of the first embodiment where multiple (e.g., two pieces) mobile terminals 20 (the smartphone 20a and the tablet 20b) are coupled to the television device 10 so as to enable communication therebetween, if the video images and the content displayed on the television device 10 and the mobile terminals 20 correspond to each other, the content of the tablet 20b is switched, when the video image of the television device 10 is changed by operation (the channel changing operation) of a user of the smartphone 20a, in response to the change in video image of the television device 10 in some cases even if a user of the tablet 20b wants to continuously view the content currently displayed. In this case, the first embodiment can differentiate for each mobile terminal 20 whether the content displayed on the mobile terminals 20 (the smartphone 20a and the tablet 20b) is switched or maintained when the video image displayed on the television device 10 changes as ascribed above as an example, thereby making it possible to enhance user-friendliness.

For example, in the examples illustrated in FIGS. 9 to 13 (the example where the video image displayed on the television device 10 is changed by operation (the channel changing operation) of a user of the smartphone 20a), the content displayed on the smartphone 20a is automatically switched by only switching operation of the video image on the television device 10 using the smartphone 20a without special operation (content switching operation), thereby making it possible to enhance the convenience for the user of the smartphone 20a. In addition, in the examples illustrated in FIGS. 9 to 13, the content displayed on the tablet 20b is maintained without any change even if the video image displayed on the television device 10 is changed by operation of the user of the smartphone 20a, and thus viewing by the user of the tablet 20b is not hindered by operation of another user (the user of the smartphone 20a), thereby making it possible to enhance the convenience for the user of the tablet 20b.

As described above, in the first embodiment, when the display module 12 of the television device 10 changes from the first state to the second state, the second output module 15b of the controller 15 of the television device 10 outputs the second instruction data to the smartphone 20a or the tablet 20b so as to cause the display module 22a (22b) to display the image indicating that the display module 22a (22b) of the smartphone 20a (the tablet 20b) is switched or switchable from the third state to the fourth state. For example, in the examples illustrated in FIGS. 9 to 13, the second output module 15b outputs the second instruction data to the tablet 20b so as to display the image IM7 (refer to FIG. 13) indicating that the content is switchable such that the image IM7 overlaps with part of the image IM4 displayed on the display module 22b of the tablet 20b. As a result, a user can visually identify that the content displayed on the mobile terminal 20 is switchable in response to the change in video image displayed on the television device 10, as an example, thereby making it possible to enhance user-friendliness.

As described above, in the first embodiment, a user can change the setting information (e.g., the first table T1, the second table T2, and the third table T3 stored in the storage module 15d) used by the controller 15 of the television device 10 when the content of the mobile terminals 20 (the smartphone 20a and the tablet 20b) is switched or maintained, thereby making it possible to enhance user-friendliness, for example.

### Second Embodiment

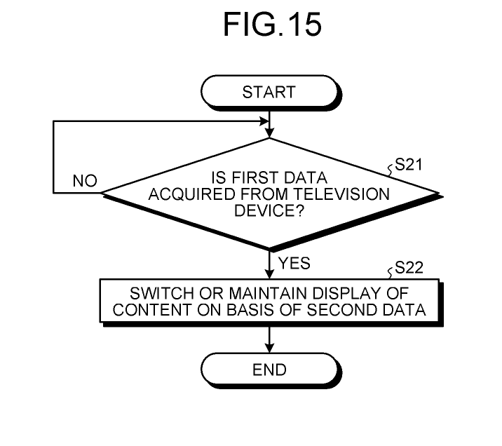

The following describes a video image display system 200 according to a second embodiment with reference to FIGS. 2 and 15. In the second embodiment, the display screens on mobile terminals 220 are switched or maintained on the basis of data (second data, which is described later) stored in the mobile terminals 220 unlike the first embodiment in which the display screens on the mobile terminals 20 are switched or maintained on the basis of the data (the first table T1, the second table T2, and the third table T3) stored in the television device 10. The mobile terminals 220 are examples of the “information processor (electronic device)”.

In the second embodiment (refer to FIG. 2), when a video image displayed on the display module 12 of a television device 210 changes, a controller 215 of the television device 210 transmits first data to the mobile terminals 20 (a smartphone 220a and a tablet 220b) through the communication module 13. The first data indicates that the video image on the display module 12 is changed. The smartphone 220a is an example of a “first information processor” and the tablet 220b is an example of a “second information processor”.

A controller 224a (224b) of the smartphone 220a (the tablet 220b) controls the display module 22a (22b), when the controller 224a (224b) receives the first data through the communication module 21a (21b), so as to switch the content displayed on the display module 22a (22b) in response to the change in video image of the display module 12 of the television device 210 or so as to maintain the content displayed on the display module 22a (22b) without response to the change in video image of the display module 12 of the television device 210. The controller 224a (224b) controls the display module 22a (22b) on the basis of the second data stored in a storage module (not illustrated) comprising a read only memory (ROM) and a random access memory (RAM).

The second data corresponds to a control rule of how to control the display module 22a (22b) when the video image of the display module 12 of the television device 210 changes. That is, the second data corresponds to the third table T3 (refer to FIG. 7) stored in the television device 10 in the first embodiment. The second data can be arbitrarily set and changed by a user.

The following describes a flowchart of processing performed by the controller 224a (224b) of the smartphone 220a (the tablet 220b) in the second embodiment with reference to FIG. 15.

In the processing flow illustrated in FIG. 15, at S21, processing is performed that determines whether the first data transmitted from the television device 210 is acquired through the communication module 21a (21b) when the video image displayed on the display module 12 of the television device 210 changes. The processing at S21 is repeated until it is determined that the first data is acquired. If it is determined, at S21, that the first data is acquired, the processing proceeds to S22.

At S22, processing is performed that switches the content displayed on the display module 22a (22b) so as to correspond to a change in video image displayed on the display module 12 of the television device 210 or maintains the content displayed on the display module 22a (22b) on the basis of the second data stored in the storage module (not illustrated). Thereafter, the processing ends.

As described above, in the second embodiment, the controller 224a (224b) of the smartphone 220a (the tablet 220b) as the mobile terminal 220 controls the display module 22a (22b), when the video image displayed on the television device 210 changes, so as to switch or maintain the content on the basis of the second data stored in the storage module (not illustrated). As a result, in the same manner as the first embodiment, the second embodiment can also differentiate for each mobile terminal 220 whether the content displayed on the mobile terminals 220 is switched or maintained when the video image displayed on the television device 210 changes, for example.

In the second embodiment, the second data stored in the smartphone 220a (the tablet 220b) can be relatively simply set and changed by a user, thereby making it possible for a user of the smartphone 220a (the tablet 220b) to relatively simply set formats of switching or maintaining of the content displayed on the smartphone 220a (the tablet 220b) when the video image of the television device 210 changes, for example. As a result, user-friendliness can be enhanced, for example.

The television devices and the mobile terminals (the smartphones and the tablets) in the first and the second embodiments have hardware structures using typical computers. Programs executed by the respective controllers of the television devices and the mobile terminals are stored in the storage modules comprising ROMs and RAMS. The programs are provided as computer program products which are recorded into storage media readable by computers in formats installable in or files executable by the computers. Examples of the storage media include compact disk ROMs (CD-ROMs), flexible disks (FDs), CD-recordable (CD-Rs), and digital versatile disks (DVDs). The programs may be stored in a computer connected to a network such as the Internet and provided or delivered through the network. The programs may be provided by being preliminarily stored in ROMs.

In the first and second embodiments, the television devices are described as examples of the broadcast receiver of the invention. The invention is also applicable to other broadcast receivers (e.g., recording devices such as blue-ray disc recorders (BD recorders), and set-top boxes) besides the television devices. In the first and the second embodiments, the mobile terminals (the smartphones and the tablets) are described as examples of the information processor of the invention. The invention is also applicable to other information processing devices (such as personal computers (PCs)) besides the mobile terminals.

The number of components in the first and second embodiments can be changed to any number. That is, in the embodiments, the number of mobile terminals (information processors) connected to the television device (broadcast receiver) so as to enable communication therebetween is two, but the number of mobile terminals may be one or more than two.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A broadcast receiver comprising:
a receiving module configured to receive broadcast waves;
a display controller configured to output display data causing a first display module to display a video image based upon the broadcast waves; and
an output module configured to output, when the first display module changes from a first state where a first video image is displayed to a second state where a second video image is displayed, first instruction to at least a first information processor configured to switch a second display module of the first information processor from a third state where first content is displayed to a fourth state where second content is displayed and configured to maintain a third display module of a second information processor in the third state, the first and the second information processors being coupled to the broadcast receiver, the first and second content based upon the first and second video images, respectively.

2. The broadcast receiver of claim 1, wherein, when the first display module changes from the first state to the second state, the output module is configured to output second instruction to the first information processor or the second information processor configured to cause the second display module or the third display module to display an image indicating that the second display module or the third display module is switched or switchable from the third state to the fourth state.

3. The broadcast receiver of claim 1, further comprising an acquisition module configured to acquire third instruction causing the first display module to change from the first state to the second state, wherein, when the acquisition module acquires the third instruction output by the first information processor, the output module is configured to output the first instruction to at least the first information processor configured to switch the second display module from the third state to the fourth state and so as to maintain the third display module in the third state.

4. A broadcast receiver comprising:
a receiving module configured to receive broadcast waves;
a display controller configured to output display data causing a first display module to display a video image based upon the broadcast waves; and
an output module configured to output, when the first display module changes from a first state where a first video image is displayed to a second state where a second video image is displayed, instruction to an information processor configured to cause the information processor to control a second display module of the information processor so that the second display switches from a third state where first content is displayed to a fourth state where second content is displayed or the second display maintains the third state, the information processor being couples to the broadcast receiver, the first and second content based upon the first and second video images, respectively.

5. A computer program product having a non-transitory computer readable medium including programmed instructions, wherein the instructions, when executed by a computer, cause the computer to perform:
acquiring first data indicating that a first display module of a broadcast receiver changes from a first state where a first video image is displayed to a second state where a second video image is displayed; and
controlling, when an information processor acquires the first data, a second display module of the information processor in accordance with second data stored in the information processor configured to switch the second display module from a third state where first content is displayed to a fourth state where second content is displayed or configured to maintain the second display module in the third state, the first and second content based upon the first and second video images, respectively.
